(19) United States
(12) Patent Application Publication
(10) Pub. No.: US 2017/0118528 A1
(43) Pub. Date: Apr. 27, 2017

(54) SYSTEM AND METHOD FOR ADAPTIVE VIDEO STREAMING

(71) Applicant: FLIR Commercial Systems, Inc., Wilsonville, OR (US)

(72) Inventors: Oren BEN-HAIM, Tel Aviv (IL); Adar KAISAR, Tel Aviv (IL); Amir ANTER, Ramat Gan (IL)

(21) Appl. No.: 14/918,715

(22) Filed: Oct. 21, 2015

(51) Int. Cl. H04N 21/61; H04N 21/4223; H04N 21/44; H04N 21/235; H04N 21/2343

(52) U.S. Cl. CPC H04N 21/6125; H04N 21/2358; H04N 21/234363; H04N 21/44008; H04N 21/4223

(57) ABSTRACT

A system and method for streaming video content may include configuring a camera to produce a plurality of video streams according to a respective plurality of resolutions. A pixel count of a display area may be determined. A video stream may be selected based on the pixel count, and a camera may be caused to send the selected video stream to the display.

### FIELD OF THE INVENTION

The present invention relates generally to streaming of video content. More specifically, the present invention relates to adaptively selecting a video stream for presentation on a display.

### BACKGROUND OF THE INVENTION

Streaming of video content from a camera to a display is known in the art. However, current systems and methods suffer from a number of drawbacks. For example, substantial computing resources are required in order to decode high resolution video content produced by a camera and/or in order to render high resolution video content on a display. In addition, substantial networking resources are required in order to transmit high resolution video content.

### SUMMARY OF THE INVENTION

A system and method for streaming video content may include configuring a camera to produce a plurality of video streams according to a respective plurality of resolutions. A pixel count of a display area may be determined. A video stream may be selected based on the pixel count, and a camera may be caused to send the selected video stream to the display.

A system and method may include: identifying a change of a display area used for displaying a video content, the change resulting a new display area; determining a pixel count of the new display area; selecting another one of the video streams based on the pixel count of the new area; and causing the camera to send the selected video stream to the display.

A system and method may include selecting a video stream having the lowest resolution that is higher than (or equal to) the resolution of an area in a display used for displaying the video content. A selected video stream may be sent, unchanged and as produced by a camera, directly from the camera to the display.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a high level block diagram of an exemplary computing device according to embodiments of the present invention;

FIG. 2 shows an overview of a system according to embodiments of the present invention; and

FIG. 3 shows a flowchart of a method according to an embodiment of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

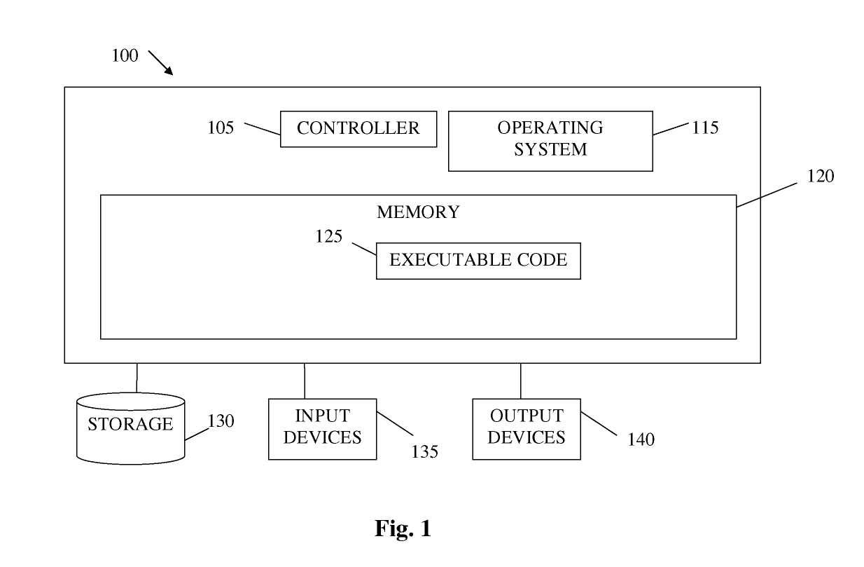

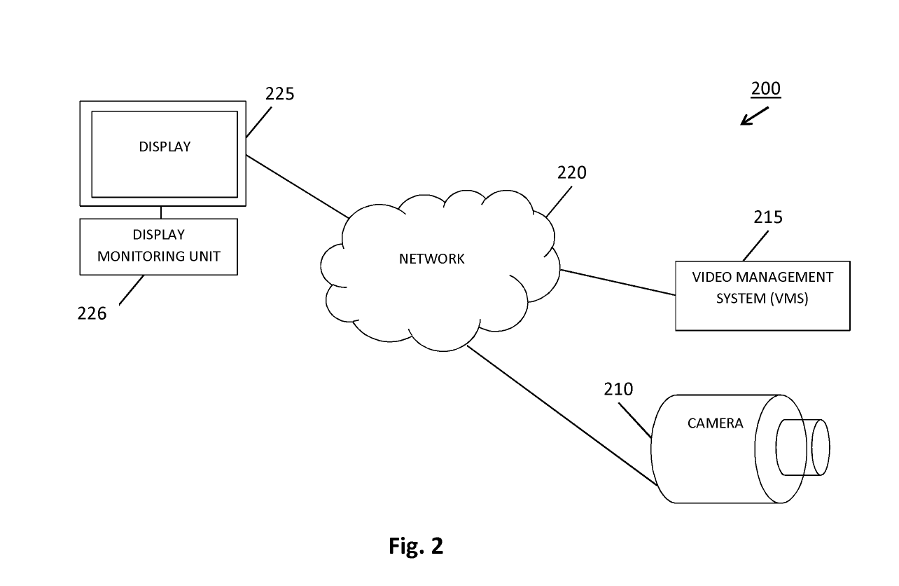

Reference is made to FIG. 1, showing a high level block diagram of an exemplary computing device according to embodiments of the present invention. Computing device 100 may include a controller 105 that may be, for example, a central processing unit processor (CPU), a chip or any suitable computing or computational device, an operating system 115, a memory 120, an executable code 125, a storage system 130, input devices 135 and output devices 140. Controller 105 may be configured to carry out methods described herein, and/or to execute or act as the various modules, units, etc. More than one computing device 100 may be included in a system, and one or more computing devices 100 may act as the various components of a system, e.g., components of system 200 shown in FIG. 2. For example, video management system 215 described herein may be, or may include components of, computing device 100. For example, by executing executable code 125 stored in memory 120, controller 105 may be configured to carry out a method of adaptive video streaming as described herein. For example, controller 105 may be configured to a camera to produce a plurality of video streams according to a respective plurality of resolutions, receive a pixel count of a display area and use the pixel count to selecting one of the video streams. Controller 105 may be configured to cause a camera to send a selected video stream to a display as described herein.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or enabling software programs or other modules or units to communicate. Operating system 115 may be a commercial operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that selects a video stream based on a pixel count and causes a camera to send the selected video stream to a display as further described herein. Although, for the sake of clarity, a single item of executable code 125 is shown in FIG. 1, a system according to embodiments of the invention may include a plurality of executable code segments similar to executable code 125 that may be loaded into memory 120 and cause controller 105 to carry out methods described herein. For example, units or modules described herein (e.g., video management system 215) may be, or may include, controller 105, memory 120 and executable code 125.

Storage system 130 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content may be stored in storage system 130 and may be loaded from storage system 130 into memory 120 where it may be processed by controller 105. In some embodiments, some of the components shown in FIG. 1 may be omitted. For example, memory 120 may be a non-volatile memory having the storage capacity of storage system 130. Accordingly, although shown as a separate component, storage system 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays or monitors, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a printer, a universal serial bus (USB) device or external hard drive may be included in input devices 135 and/or output devices 140.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105.

Some embodiments may be provided in a computer program product that may include a non-transitory machine-readable medium, having stored thereon instructions, which may be used to program a computer, controller, or other programmable devices, to perform methods as disclosed herein. Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more devices such as computing device 100.

As referred to herein, a display may include any device, system or component needed or required in order to present or display video and/or audio content. For example, a display (e.g., display 225 described herein) may include a screen or monitor as known in the art and may further include a processor, memory and a network interface card. Accordingly, a display as referred to herein may receive, over a network, video and audio content from a camera and present the received content on a monitor. For example, a display as referred to herein may include a computer and a monitor operatively connected to the computer. A display may record a received video stream. Accordingly, it will be understood that a video stream selected based on a pixel count as described herein may be recorded by a display. For example, a display may be, or may include components of, computing device 100 and a video stream received by a display may be recorded, e.g., stored on a storage system 130. Any other processing of video content may be performed by a display (e.g., by display 225). For example, processing of a video stream may include transcoding, compression and/or de-compression; video analytics (e.g., face recognition, searching for specific objects in a video stream, and the like.)

As discussed in the background, current or known systems and methods require substantial resources in order to produce, transmit and display high resolution video content. For example, 4K resolution (also known as 4K in the art) refers to content having horizontal resolution of 4,000 pixels, e.g., 4096×2160 pixels.

Accordingly, in order to display a 4K stream, known systems and methods need to process a video stream before it can be displayed on a display that cannot handle the 4K resolution. Moreover, a 4K stream has a frame size of 8 mega bit (Mb) and a bit rate that can vary between two to seven (2-7) Mbits per second. Therefore, using a 4K stream may require substantial network capacity as well as other resources.

Displaying a video stream on a portion or region of a display (also known as “tile” in the art) that has fewer pixels than the steam resolution is wasteful since the same video quality can be achieved with a lower resolution stream. Generally, as long as the video pixel count isn't smaller than the tile's pixel count, increasing the video pixel count does not result any benefit with respect to the presentation of the video stream on the display or tile.

For example, there is no benefit to use a 4K stream on an 1080P monitor, even if the tile size is full screen, and there is no benefit to use a 4K stream on a 4K monitor if a tile used for displaying the video is smaller than the entire monitor,

On the other hand, it may be beneficial to use a 4K video stream on a 4K monitor to display the video in full screen mode. In another case, it may be beneficial to use a 4K video stream on a 1080P monitor in case of zooming, because the additional pixels of the 4K stream can provide more details when zooming.

Unable to adaptively adjust the resolution of a video stream to the capability or capacity of the display, known systems and methods may provide poor resolution, e.g., by using a video stream with a resolution that is lower than the resolution of the display used. Unable to adaptively adjust the resolution of a video stream to the capability or capacity of the display, known systems and methods may require substantial computing and networking resources, e.g., when generating and transmitting a video stream with a resolution that is higher than the resolution of the target display. For example, not only is generating and transmitting a video stream with a resolution that is higher than the resolution of the target display wasteful in terms of networking (e.g., due to transmission of redundant data) such video stream needs to be processed (e.g., to reduce its bit rate) before it can be properly displayed. For example, known systems and methods send a video stream from a camera to a server that processes the video stream (e.g., to reduces its bit rate) and then sends the video stream to the target display. In other cases, known systems and methods leave the burden of processing a video stream to the target display, for example, a computer connected to the target display adapts a received video stream to the capabilities or needs of a connected display, screen or monitor.

The terms “display”, “screen” and “monitor” as used herein may refer to any device or component usable for presenting video content as known in the art and may be used herein interchangeably. For the sake of simplicity, a display, screen and monitor as referred to herein may include a computing device connected to the display. For example, a server or a personal or portable computer (PC) connected to a monitor may be referred to herein as a target display.

The term “tile” as referred to herein may be related to a region, area or portion of a display screen. For example, a video stream may be presented on an entire screen (e.g., in full screen mode as known in the art) or it may be displayed or presented in a tile that covers a part or portion of the screen. The terms “screen layout” or simply “layout” as used herein may relate to an arrangement of a display screen. For example, a layout may refer to a number or arrangement of tiles on a display screen, a full screen mode and so on.

Although, for the sake of clarity and simplicity, presenting or displaying a video stream is mainly discussed herein, it will be understood that a video stream may be recorded by a display. For example, display 225 may record a video stream as well as present the video stream or it may only record the stream, e.g., without displaying it. In some embodiments, a video stream may be selected and sent to a client as described herein based on recording requirements and not based on presentation requirements.

For example, if a recording of high resolution video content (e.g., 4K resolution) is required (or requested by a user), then a high resolution stream may be selected, or generated by camera 210 and sent to display 225 where it may be recorded. If, e.g., based on a user request, or due to storage limitations on display 225, a lower resolution stream is needed, then a system and method according to embodiments of the invention may automatically and adaptively select a lower resolution stream produced by camera 210 (or automatically cause camera 210 to generate a lower resolution stream as described herein) and the lower resolution stream may be sent to display 225 and recorded thereon.

For example, in some embodiments, display monitoring unit 226 may monitor the capacity of a storage system connected to display 225 (e.g., of storage system 130 that may be used for storing recorded video on display 225) and, upon determining that a storage capacity threshold was reached or breached, display monitoring unit 226 may automatically cause a system and method to select a lower resolution video stream of camera 210 to be sent to display 225. For example, if monitoring unit 226 determines that 100 GB of storage is available on storage system 130 then monitoring unit 226 may cause a 4K video stream be selected (or generated) for transmission to display 225 where the stream may be recorded as described herein. IF or when (e.g., at a later stage) monitoring unit 226 determines that only 10 GB of storage are available on storage system 130, then monitoring unit 226 may cause (e.g., as described herein) a 720P or D1 (or other lower resolution) video stream be selected or generated for transmission to display 225 where the 720P or D1 may be recorded. Accordingly, embodiments of the invention may guarantee that video content is recorded by automatically and adaptively adjusting the resolution of a generated, selected and/or transmitted video stream.

The term “real-time” (also known in the art as “realtime”, or “real time”) as referred to herein generally relates to processing or handling of events at the rate or pace that the events occur, identified or received. For example, a system according to some embodiments of the invention may select video streams in real-time, e.g., within milliseconds or other very brief periods so that a change of video streams is smoothed and unnoticed by a user. For example, when a user zooms in to a display of a video, a system and method as described herein may, in real-time, switch from a first video steam to a second video stream as described herein.

As described herein, a system and method according to some embodiments of the invention may adaptively produce, select and transmit an optimal video stream to be displayed on a display screen or recorded by a client. For example and as described, a system and method according to some embodiments of the invention may determine or identify a presentation capacity of a display and cause a camera to produce and send an optimal video stream to the display. For example, based on a pixel count of an area, portion, region or tile used for displaying video content on a display, a system and method according to some embodiments of the invention may select a video stream produced by a camera and cause the camera to send the selected video stream to the display. A video stream selected and transmitted as described herein may be recorded by a client. For example, display 225 may be a computing device that may record a video stream sent from camera 210 as described herein.

As described, a system and method according to some embodiments of the invention may adapt a high bit rate video stream to the limitations of a display such that transmission bandwidth and client-side or other processing resource usage for decoding and rendering of the video content are optimally used.

Reference is made to FIG. 2, an overview of a system 200 according to some embodiments of the present invention. As shown, a system 200 may include a camera 215, a video management system (VMS) 215, a network 220 and a display 225.

Camera 215 may be any camera capable of capturing or recording video content as known in the art, e.g., camera 215 may be a device usable for electronic motion picture acquisition. Camera 215 may be a device adapted to communicate over network 220 and may, as shown, be connected to a network. For example, camera 215 may be DVTEL's Quasar UHD camera (e.g., as described in http://www.dvtel.com/4k/). Camera 215 may be configured to generate or produce a number of video streams for a scene.

It will be understood that any camera may be used as camera 215 without departing from the scope of the invention. For example, camera 215 may be any suitable video acquisition device or system located in a remote site, may capture a scene in the remote site and may, based on a configuration received from VMS 215, generate a number of video streams that include the captured scene.

VMS 215 may be, or may include components of, computing device 100. For example, VMS 215 may include a controller 105 and a memory 120 and input devices 135 and/or output devices 140 may enable VMS 215 to communicate over network 220. Although only one camera 210 and one VMS 215 are shown in FIG. 2 it will be understood that a system and method according to some embodiments of the invention may include any number of cameras 210 and VMS's 215. VMS 215 may be used as an interface between a server (not shown) and camera 210. For example, a server connected to network 220 may send one or more configuration parameters (e.g., the number of video streams camera 210 is to generate and the respective bit rates of the video streams) to VMS 212 and VMS 215 may configure camera 210 based on configuration data received from a server. In other embodiments, display monitoring unit 226 may send configuration parameters to camera 210 or to VMS 215.

Although VMS 215 is shown as a separate, or standalone component, other configurations or embodiments may be contemplated. For example, VMS 215 may be a software module or unit included, or embedded in, a server on network 220. In some embodiments, VMS 215 may be embedded in camera 210 or camera 210 and VMS 215 may otherwise be included in the same device, system or component. Although only one camera 210 and one VMS 215 are shown in FIG. 2 it will be understood that a system and method according to some embodiments of the invention may include any number of cameras 210 and VMS's 215.

Network 220 may be, may comprise or may be part of a private or public IP network, or the internet, or a combination thereof. Additionally or alternatively, network 220 may be, comprise or be part of a global system for mobile communications (GSM) network. For example, network 220 may include or comprise an IP network such as the internet, a GSM related network and any equipment for bridging or otherwise connecting such networks as known in the art. In addition, network 220 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, a satellite communication network, a cellular communication network, any combination of the preceding and/or any other suitable communication means. Accordingly, numerous elements of network 220 are implied but not shown, e.g., access points, base stations, communication satellites, GPS satellites, routers, telephone switches, etc. It will be recognized that embodiments of the invention are not limited by the nature of network 220.

Display 225 may be a computing device (e.g., similar to computing device 100) that includes a screen, projector, display, monitor or any other component of system suitable for displaying video content. As shown, display 225 may be connected to network 220, may receive, from camera 210, a video stream and may display the received video stream in an attached display. Display monitoring unit 226 may be any unit, module or component adapted to monitor display 225 and determine a layout of elements on display 225. For example, display monitoring unit 226 may communicate with an operating system in display 225 or with a video presentation software module on display 225 and may identify or determine a position, size, orientation or any other aspect of a tile or region in display 225 used for displaying video content. Display monitoring unit 226 may identify changes in a layout or other aspects of display 225 and/or of a tile presenting video content received from camera 210. Display monitoring unit 226 may inform VMS 215 or a server of any changes in a layout of display 225. For example, display monitoring unit may identify the size of a tile used for presenting video content received from camera 210, e.g., the size as set or selected by a user. Upon a change of the size of a tile used for presenting video content received from camera 210 (e.g., when a user increases the size of a tile or window displaying the video content), display monitoring unit 226 may report the new size of the tile to VMS 215 and/or a server. Display monitoring unit 226 may communicate to VMS 215 any relevant information. For example, upon identifying or determining a zoom-in or zoom-out in a tile or window presenting video content from camera 210, display monitoring unit 226 may inform VMS 215 of such operations. As described herein, using, or based on, information received from display monitoring unit 226, a system and method according to some embodiments of the invention may adaptively select a video stream to be sent to display 225.

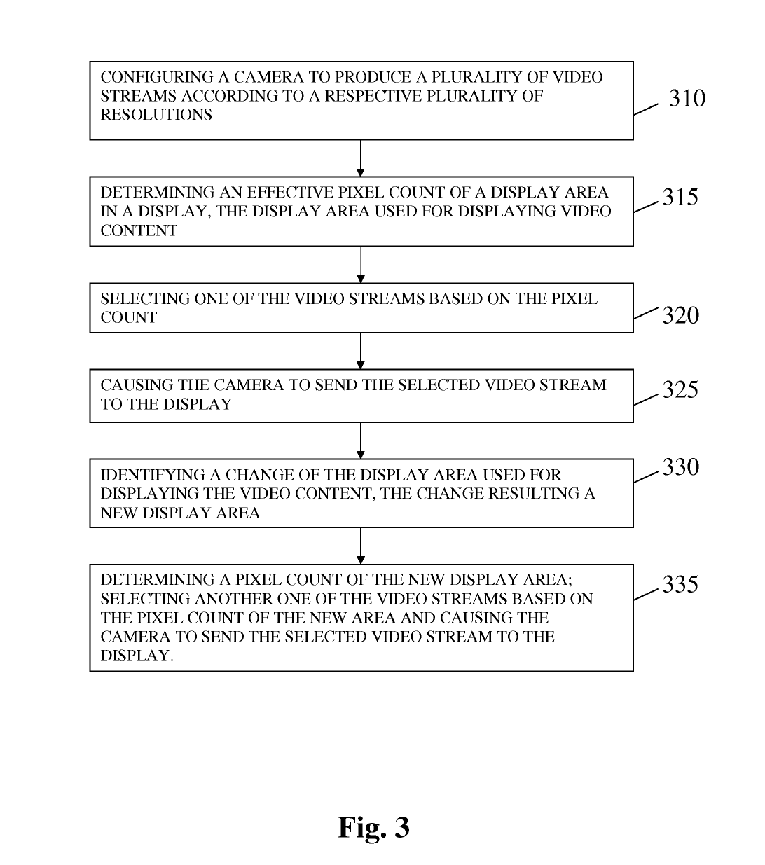

Reference is made to FIG. 3, flowchart of a method according to an embodiment of the present invention. As shown by block 310, a camera may be configured to produce a plurality of video streams according to a respective plurality of resolutions. Various video stream resolutions and their notations are known in the art, e.g., 4K (4096'2160 pixels) 1080P (1920×1080 pixels), 720P (1280×720 pixels) and D1 (720×480 pixels). For example, DVTEL Quasar UHD camera can be configured to produce four different video streams with the respective four different resolutions of 4K (also known as ultra-high-definition (UHD)), 1080P 720P and D1. In some embodiments, an initial set of video streams may be used. For example, VMS 215 may initially (e.g., after a deployment of a new system or after a reset of a system) configure camera 210 to produce an initial set or range of video streams that is likely to be suitable for most use cases and/or tile sizes. For example, the set of 4K (or UHD), 1080P, 720P and D1 may be used as an initial or default video streams set.

It will be understood that any number of video streams having any resolutions may be produced, selected and used by embodiments of the invention, and that the scope of the invention is not limited by the format, number or resolutions of video streams produced by a camera. For example, a system and method according to embodiments of the invention may select one video stream from a set of 5, 10, 20 or any other number of streams produced by a camera according to any digital video formats (e.g., D1, 720P, 4K UHD or 8K UHD) and cause the selected stream to be sent to, and displayed or recorded by, a display as described herein. Accordingly, a system and method may support any (possibly future) video formats, e.g., a future 7K video stream may be selected for transmission to, and presentation by, a display as described.

It will be understood that a camera, e.g., camera 210, may be configured to produce any set of video streams according to any set of resolutions. For example, based on the pixel count of display 225 or based on the pixel count of a region used for presenting video content in display 225 as reported by display monitoring unit 226, VMS 215 may configure camera 210 to produce a video stream that has a pixel count that has a resolution that is close to, or same as, the pixel count reported by display monitoring unit 226. Pixel count and video stream resolution are related terms and may be used herein interchangeably. For example, the pixel count of a video stream with a resolution of D1 is 720×480. Accordingly, in some embodiments of the invention, the pixel count or resolution of video streams produced by a camera may be dynamically set or configured based on a display area used for displaying the video content.

As shown by block 315, an effective pixel count of a display area in a display may be determined. For example, display monitoring unit 226 may determine the pixel count and/or size of a tile used for displaying video content on display 225 and may inform VMS 215 of the pixel count or size. Determining a size or pixel count of a tile on a display is known in the art, e.g., by hooking or interacting with an operating system, a windowing system and the like, accordingly, display monitoring unit 226 may use any system or method as known in the art in order to identify or determine the size of a tile or region in display 225 used for displaying video content provided by camera 210.

As shown by block 320, one of the video streams produced by a camera may be selected based on the pixel count. For example, a system and method for adaptive streaming according to some embodiments of the invention may dynamically select, from a plurality of video streams produced by a camera, one video stream based on a pixel count of a display area used for displaying video content. For example, based on a pixel count of an area in display 225, VMS 215 may select one of the UHD, 1080P, 720P and D1 video streams produced by camera 210.

In some embodiments, a video stream selected from a set of stream may be the one that has the lowest resolution that is also higher than, or equal to, the resolution of the area used for displaying the video content. For example, the video stream selected as shown by block 320 may be a video stream that is closest, in terms of pixel count or resolution, to the area used for displaying the video content. For example, in order to both prevent loss of quality and optimize resource usage, the video stream selected by VMS 215 may be the one that either has exactly the same pixel count of the display area used, or the one that is just above, in terms of pixel count, the display area used.

For example, if the pixel count of the tile or region used for displaying video content on display 225 is 1080×620 pixels then a D1 (720×480 pixels) video stream may have a less than optimal pixels count as it may cause loss of quality and therefore, in such case, VMS 215 may select a 720P (1280×720 pixels) video stream. Of course, if the pixel count of the area used for displaying video content is exactly 720×480 pixels, then VMS 215 may select a D1 video stream as shown by block 320.

As shown by block 325, a camera may be caused to send a selected video stream to a display. For example, VMS 215 may cause camera 210 to send the selected video stream to display 225. In some embodiments, the selected video stream may be sent, unchanged and as produced by a camera, directly from the camera to a display. For example, a selected video stream may be sent directly, unprocessed, from camera 210 to display 225. Systems and methods known in the art cause a camera to send a video stream to a server or other unit where the video stream is processed (e.g., down sampled) and then send the processed video stream to a display. Other systems and methods known in the art process a video stream by the receiving end, for example, if a video stream received by a display unit is unsuitable for displaying by the display unit (e.g., the streams resolution is too high) then the display unit process the stream prior to displaying it. Since some embodiments of the invention may select a video stream provided by a camera based on the capabilities or constraints of the displaying unit, some embodiments of the invention enable sending the stream, unchanged and/or unprocessed, directly to the display unit, and some embodiments of the invention enable displaying content in a received video stream without having to process the received video stream.

As shown by block 330, a change of the display area used for displaying the video content may be identified. Display monitoring unit 226 may identify or determine any change of the display area used for displaying video content where the change results in a new display area, tile or window used for displaying the video content.

For example, display monitoring unit 226 may identify or determine that a user or application has changed the size of the tile used for displaying video content on display 225. As known in the art, the size of a window or tile may be changed by dragging a side or corner of the tile, or the size may be changed by double clicking the top of a tile or window to cause the tile to cover the entire screen (e.g., assume full screen mode). Any change of a layout on display 225, or change of a tile used for displaying the video content may be identified by a system or method according to some embodiments of the invention, e.g., by display monitoring unit 226.

As shown by block 330, a pixel count of a new display area (or tile) may be determined (e.g., by display monitoring unit 226 as described herein). As further shown by block 330, another or different video stream may be selected based on the new display area or tile and a camera may be caused to send the selected video stream. For example, if a camera is configured to produce a set of video streams and a first video stream is initially selected then, following a change of the display area, another, different video stream may be selected from the set and the camera may be caused to send the newly selected stream instead of the initially sent stream.

Accordingly, a system and method according to some embodiments of the invention may adaptively, dynamically and automatically adapt streaming of video content to the pixel count or other aspects of a display used for displaying video content.

For example, assuming that, during a first time period, a 720P video stream is sent from camera 210 to display 225 and displayed or recorded thereon. If a user then reduces the size of a tile or window in which the video is displayed, monitoring unit 226 may track or identify the change, calculate or determine the pixel count of the reduced tile and inform VMS 215 of the change and/or the new pixel count. VMS 215 may then cause camera 210 to stop sending the 720P video stream to display 225 and further cause camera 210 to send a D1 video stream instead. It will be noted that the changing of video streams sent from a camera to a display as described may be fully automated by systems and methods according to the invention and may be done without any intervention, knowledge or even awareness of the user. As described, switching video streams may be done in real-time, such that a user may not notice that streams were switched. For example, the process of identifying a change in pixel count, causing a camera to send a new or different video stream to a display, and replacing a previous stream with the new stream may be done in milliseconds.

According to some embodiments of the invention, various triggers, operations or conditions may cause an automatic and dynamic selection of a video stream to be sent from a camera to a display. For example, a zoom operation may cause automatic selection (or replacement) of a video stream sent from a camera to a display. For example, upon detecting (e.g., by monitoring unit 226) that a user has zoomed in to a display, monitoring unit 226 may inform VMS 215 of the zoom operation or change, possibly including in a message the rate of zoom, the new pixel count used after the zoom, and VMS may select a higher resolution stream to be sent from camera 210 to display 225. The process of selecting video streams may be continuous. For example, when a user starts to zoom in, VMS 215 may automatically and continuously cause camera 210 to switch from low resolution streams to higher resolution streams, e.g., according to the zoom level and the tile effective area. For example, assume the initial tile size is D1 and the user starts zooming in, in such case, VMS 215 may cause camera 210 to switch from a D1 stream sent to display 210 to a 720P stream then, if the user keeps zooming in, to a 1080P stream and, if the user keeps zooming in, to a UHD stream. Similarly, upon being informed by monitoring unit 226 that a zoom out is performed, VMS 215 may cause camera 210 to switch from a 4K stream to a 1080P stream, then, if needed, a 720P stream and so on. Accordingly, selecting and sending video streams to a display may be automatic, dynamic and continuous.

As described herein, a system and method according to some embodiments of the invention may perform adaptive video streaming automatically, without user configuration or intervention. A system and method according to some embodiments of the invention may perform adaptive video streaming in a manner that is completely transparent to a user or client. For example, selecting and switching between streams may be done automatically while video is always available to the user, e.g., switching from one stream to another includes first providing a new stream and then terminating a communication of an old or redundant stream. For example, when a stream switch is required, VMS 215 sets up the new stream in the background and when the stream is ready (e.g., camera 210 produces and sends the new stream), the currently displayed stream is replaced by the new stream.

According to some embodiments of the invention, camera 210 may only send (or broadcast) streams that are displayed or recorded. For example, in an embodiment, streams which are not displayed, recorder or otherwise used are not produced nor sent by camera 210, and, accordingly, network resources are optimally used, for example, by sending only video streams used by display 225; redundant data is not sent over network 220. Of course, if more than one display is connected to network 220 and a number of video streams are used by a number of displays then all required streams are produced and sent over the network; however, only the required streams may be sent thus keeping usage of network 220 at an optimal or minimal usage.

VMS 215 may configure camera 210 to produce only video streams being used for displaying or recording the video content. For example, a first one of the video streams produced by camera 210 may be selected for sending to a first display 225, and a second one of the video streams produced by camera 210 may be selected for sending to a second display 225. If a third and fourth video streams generated by camera 210 are redundant, e.g., not required or needed by any display 225 on network 220 then VMS 215 may cause camera 210 to stop producing the redundant streams.

Multicast and unicast transmissions of video streams may be used by some embodiments of the invention. Multicast and unicast are known in the art and may be used by some embodiments of the invention. For example, sending a video stream from camera 210 to a plurality of clients or display 225 using multicasting may include sending one video stream from camera 210 to a network node and sending a plurality of video streams from the network node to the plurality of clients. For example, a plurality of displays 225 may register with a switch on network 220 (not shown), camera 210 may send a video stream to the switch and the switch may send a copy of the video stream to each of the registered displays 225. It is noted that, in some embodiments, no server is used for receiving, sending or transmitting a video stream when using multicasting as described herein.

Some embodiments of the invention may use unicast transmission. For example, camera 210 may send a selected video stream to one specific client or display 225, e.g., using an internet protocol (IP) address of the client. Accordingly, streams may be sent directly to a client, user or display as described, e.g., directly from camera 210 to display 225. It will be noted that some embodiments of the invention are not required to perform CPU or memory intensive operations (such as transcoding performed by servers in systems and methods known in the art) in order to support the adaptive streaming functionality. It will be understood that a system and method according to some embodiments of the invention (e.g., system 200 and the method shown in FIG. 3) may support an unlimited number of streams that may be used by an adaptive streaming method or system as described herein.

A limitation of the number of streams available to a system and method according to some embodiments of the invention may be related to the number of streams produced by a camera but not to the processing power of a network server or other units described herein. For example, upon determining or identifying a change or a required pixel count of a display, VMS 215 may configure or cause camera 210 to produce a video stream according to the required pixel count. Accordingly, a system and method according to some embodiments of the invention may produce or generated a video stream on demand, as or when required. A dynamically produced video stream may be automatically sent to a display. For example, upon detecting or identifying a required pixel count on display 210, VMS 215 may cause camera 210 to start generating a new video stream based on the required pixel count, e.g., a new video stream that was not previously generated by camera 210. VMS 215 may cause camera 210 to send a new video stream to display 225. Accordingly, generating and sending a video stream may be fully adaptive, dynamic and automatic according to some embodiments of the invention.

In some embodiments, generation of a video stream may be dynamic and automatic. A system and method according to some embodiments of the invention may generate and send a video stream on demand. For example, a system and method according to some embodiments of the invention may first determine a pixel count of a display area used for displaying video content in a display and then configure or cause a camera to produce a video stream according to the pixel count and send the video stream to the display. An effect of a change or operation related to a display area on a pixel count may be determined. For example, a change in size of a tile as described, or a zoom-in or zoom-out operation may change the pixel count or resolution of a display area or tile in a display as described. For example, display monitoring unit 226 may calculate or determine an effect on the pixel count, e.g., by calculating or counting the pixels included in a resized tile or after a zoom operation was made. VMS 215 may configure a camera to produce a new video stream according to the effect on the pixel count and may cause the camera to send the new video stream to the display.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method for streaming video content, the method comprising:
configuring a camera to produce a plurality of video streams according to a respective plurality of resolutions;
determining an effective pixel count of a display area in a display, the display area used for displaying video content;
selecting one of the video streams based on the pixel count; and
causing the camera to send the selected video stream to the display.

2. The method of claim 1, comprising:
identifying a change of the display area used for displaying the video content, the change resulting a new display area;
determining a pixel count of the new display area;
selecting another one of the video streams based on the pixel count of the new area; and
causing the camera to send the selected video stream to the display.

3. The method of claim 2, wherein the change of the area used for displaying the video content includes one of: a zoom in and a zoom out.

4. The method of claim 1, comprising selecting a video stream having the lowest resolution that is higher than or equal to the resolution of the area used for displaying the video content.

5. The method of claim 1, comprising selecting a first one of the video streams for sending to a first display and selecting a second one of the video streams for sending to a second display.

6. The method of claim 1, comprising configuring the camera to only produce video streams being used for one of: displaying the video content and recording the video content.

7. The method of claim 1, comprising using at least one of: multicast transmission and unicast transmission to send a selected video stream to a plurality of displays.

8. The method of claim 1, wherein the selected video stream is sent, unchanged and as produced by the camera, directly from the camera to the display.

9. A method for streaming video content, the method comprising:
determining a pixel count of a display area in a display, the display area used for displaying video content;
configuring a camera to produce a first video stream according to the pixel count; and
causing the camera to send the first video stream to the display.

10. The method of claim 9, comprising:
identifying a change related to the display area;
determining an effect of the change on the pixel count; and
configuring a camera to produce a second video stream according to the effect on the pixel count; and
causing the camera to send the second video stream to the display.

11. The method of claim 9, comprising using at least one of: multicast transmission and unicast transmission to send the video stream to a plurality of displays.

12. The method of claim 9, wherein the video stream is sent, unchanged and as produced by the camera, directly from the camera to the display.

13. A system comprising:
a first unit adapted to determine an effective pixel count of a display area in a display, the display area used for displaying video content; and
a second unit adapted to:
configure a camera to produce a plurality of video streams according to a respective plurality of resolutions,
select one of the video streams based on the pixel count, and
cause the camera to send the selected video stream to the display.

14. The system of claim 13, wherein:
the first unit is adapted to:
identify a change of the display area used for displaying the video content, the change resulting a new display area, and
determine a pixel count of the new display area; and
the second unit is adapted to:
select another one of the video streams based on the pixel count of the new area, and
cause the camera to send the selected video stream to the display.

15. The system of claim 14, wherein the change of the area used for displaying the video content includes one of: a zoom in and a zoom out.

16. The system of claim 13, wherein the second unit is adapted to select a video stream having the lowest resolution that is higher than or equal to the resolution of the area used for displaying the video content.

17. The system of claim 13, wherein the second unit is adapted to select a first one of the video streams for sending to a first display and selecting a second one of the video streams for sending to a second display.

18. The system of claim 13, wherein the second unit is adapted to configure the camera to only produce video streams being used for displaying the video content.

19. The system of claim 13, wherein the camera is adapted to send a selected video stream to a plurality of displays using one of: a multicast transmission and unicast transmission.

20. The system of claim 13, wherein the selected video stream is sent, unchanged and as produced by the camera, directly from the camera to the display.
